(19) United States
(12) Patent Application Publication
(10) Pub. No.: US 2007/0154719 A1
(43) Pub. Date: Jul. 5, 2007

(54) COATED BASE PAPER

(75) Inventors: Maarten Constant G. M. Meijlink, Kaatsheuvel (NL); Jun Naito, Shizuoka (JP)

Correspondence Address: BANNER & WITCOFF, LTD., 28 STATE STREET, 28th FLOOR, BOSTON, MA, 02109-9601, US

(73) Assignee: FUJIFILM Manufacturing Europe B.V., Tilburg (NL)

(21) Appl. No.: 11/623,767

(22) Filed: Jan. 17, 2007

Related U.S. Application Data
(63) Continuation of application No. PCT/NL05/00530, filed on Jul. 21, 2005.

(30) Foreign Application Priority Data
Jul. 21, 2004 (EP) 04077116.4

(51) Int. Cl. B32B 9/04; B05D 3/00; B05D 3/08

(52) U.S. Cl. 428/411.1; 427/326; 427/224

(57) ABSTRACT

The invention is directed to a method of producing paper support having a topside and a backside, at least said topside being provided with a pigmented coating based on clay and/or other pigment, and is provided with at least one pigmented polymer resin layer. Adhesion between the polymer resin layer and the pigment coated base paper is improved by applying an activating treatment to the base and exposing the polymer melt to an oxidizing gas prior to extrusion coating, making it possible to perform extrusion coating at higher speed.

### CROSS REFERENCE OF RELATED APPLICATIONS

This application is a continuation of PCT application no. PCT/NL2005/000530, designating the United States and filed Jul. 21, 2005; which claims the benefit of the filing date of European application no. EP 04077116.4, filed Jul. 21, 2004; both of which are hereby incorporated herein by reference in their entirety.

### FIELD OF THE INVENTION

The present invention is directed to a method of producing a base paper for photographic and/or inkjet printing paper, which printing paper comprises a pigment coated base paper sheet and a metal oxide filled polymer resin coating. Further the invention is directed to such base paper per se, as well as to a photographic or ink jet printing paper comprising such a base paper and an image recording layer on at least one side of the paper.

### BACKGROUND OF THE INVENTION

Base paper for photographic printing paper is conventionally prepared from a paper basis that is coated with a resin layer, usually a titanium oxide filled polyethylene, polypropylene or a polymethyl-methacrylate resin. An important aspect of the polymer resin coated base paper is the resin surface appearance, which should be smooth and not uneven and/or grainy. Further it is important that the resin surface does not have a large number of crater defects after melt-extrusion coating of resin on the base paper.

Further, an important aspect of photographic printing paper is the speed of production and the thickness of the polyethylene layers. Both aspects are important in view of the economy of the process of producing the photographic printing paper. The formation of crater defects, or pits, has turned out to be strongly dependent on those aspects.

It has been attempted to increase the smoothness of the base paper by calendering the paper at high pressures between metallic rolls. A limitation of this method is that calendering will also reduce the thickness of the base paper and this results in a decrease of whiteness and stiffness. Such a calender treatment is accordingly not really effective and creates other disadvantages. Also the calender treatment reduces the adhesion between the paper and the polymer resin, which has to be compensated for by the use of adhesion promoting additives in the paper, or in an additional paper coating, or by further treatment of the paper.

It has also been attempted to suppress the crater defects by increasing the thickness of the polymer resin coating layer. At high extrusion speeds, such as over 300 m/min this is not sufficiently effective. Furthermore, it has economical disadvantages as the polymer resin is an important cost factor in the production of photographic printing paper.

In US-A-4 994 357 it has been indicated, that increase of extrusion speeds above 100 m/min and more in particular above 150 m/min results in an increase of crater defects.

EP-A-0 952 483 discloses a base paper that is coated with a pigment prior to applying a polymer resin coating to improve surface properties by minimizing crater formation.

EP-A-0 867 761, EP-A-0 704 753, and EP-A-0 976 545 describe methods for manufacturing a base paper laminated with a polymer resin by exposing the polymer resin to an ozone containing gas, optionally subjecting the paper base to a flame or corona treatment. These documents are silent with respect to lamination of pigment coated base paper.

In the art of providing photographic base paper there is a need for high speed production of the paper, especially during the (co-)extrusion of the paper with the polymer resin, whereby the amount of defects in the paper (pits or crater defects) remains at a sufficiently low value by applying a pigment coating on the paper base prior to (co-)extrusion of the polymer resin, while at the same time the adhesion between the pigment coated base and the polymer resin remains at a good level.

### SUMMARY OF THE INVENTION

It is an object of the present invention to provide a photographic printing or ink jet paper, comprising a pigmented paper base and a polymer resin layer adhered to said base, with superior surface properties, i.e. a minimum amount of crater defects. It is a further object of the present invention to provide such a paper, that can be produced at very high production speed during melt extrusion-coating, with good adhesion strength between the pigment coated paper base and the (co-)extruded polymer resin layer.

It is also an object of the invention to provide a photographic paper having a good whiteness and a good stiffness in combination with a good thickness of the base paper sheet.

The present invention is based on the surprising insight, that the pigment coated paper base can be melt-extrusion coated (also referred to as “laminated”) with a low amount (thin layer) of polymer resin at high speed, without detrimental effects to the adhesion between the pigment coated paper and the polymer layer by a method for manufacturing a paper support comprising:

providing a support having a top side and a back side, at least said topside being provided with a pigmented coating;

applying a corona discharge to a pigment coated surface of said support;

laminating said pigment coated surface of said support with at least one polymer layer while exposing the side of the polymer layer contacting the pigment coated surface of the support to an oxidising gas.

With the invention it has thus become possible to provide on the one hand a paper that can be produced at high speeds, without unacceptable crater defects, having at the other hand a good adhesion between the pigment coated paper base and the polymer resin layer. Further the invention provides a paper that has a good whiteness, a good stiffness and a useful thickness.

The meaning of the term photographic paper in this application refers to a base material with a very high quality, as is required in the photographic process. It will be evident, that base materials according to the present invention can be used for any printing application.

### DESCRIPTION OF THE INVENTION

The invention is based thereon that the inventors have discovered, that adhesion between a pigment coated base paper and the polymer layer laminated thereon by, for example, melt (co-)extrusion coating can be improved by applying a corona treatment to the pigment coated base and exposing the polymer melt to an oxidizing gas, preferably ozone, prior to laminating. Although the exact mechanism of adhesion improvement by oxidation steps in the not pigment coated paper base or of the polymer melt has not been elucidated, it is generally accepted that this involves formation of active groups on the fibers present in the base paper. Coating the paper surface with a pigment layer provides a barrier between the polymer layer and the paper fibers, thereby reducing the adhesion. In order to improve the adhesion a possible solution is described in EP-A-1 126 081, in which a special pigment distribution is proposed to improve the adhesion, but this proposed countermeasure seems insufficient. Adhesion between surfaces is a very complicated phenomenon, but in a simple explanation one can state, that the surfaces which should adhere to each other should have anchor places in order to give adhesion. In general one can distinguish chemical and physical anchor places. In case of not pigment coated base paper there are physical anchor places and chemical anchor places on the cellulose fibre surfaces. Through ozone treatment chemical anchor places are introduced onto the polymer melt and the adhesion between base paper and polymer can be expected to improve. In case of pigment coating onto the paper surface the chemical anchor places of the cellulose fibres are covered and it could therefore not be expected that treating the polymer melt with ozone would improve the adhesion between the polymer layer and the pigment layer of the pigment coated paper base.

The base paper to be used as the support for the photographic printing paper of the present invention is selected from materials conventionally used in photographic printing paper. Generally it is based on natural wood pulp and if desired, a filler such as talc, calcium carbonate, TiO₂, BaSO₄ and the like. Generally the paper also contains internal sizing agents, such as starch, alkyl ketene dimer, higher fatty acids, paraffin wax, alkenyl succinic acid and the like. Further the paper may contain a reinforcing agent such as polyacrylamide or starch. Further additives in the paper can be fixing agents, such as aluminium sulphate, starch, cationic polymer and the like. In order to obtain especially good photographic printing paper usually short fibers are used in the natural pulp. A surface sizing or speed sizing may be applied, using a mixture generally comprising a binder and water. The binder may be selected from styrene-butadiene latex, methyl methacrylate-butadiene latex, polyvinyl alcohol, starch, modified starch, polyacrylate latex and the like, as well as combinations thereof.

The base paper having a top side and a back side is prepared from the above components in a conventional way using known machinery.

The pigmented coating is an aqueous dispersion comprising a binder and a pigment. Examples of suitable binders are styrene-butadiene latex, methyl methacrylate-butadiene latex, polyvinyl alcohol, starch, modified starch, polyacrylate latex and the like, as well as combinations thereof. Examples of pigments are calcium-carbonate, TiO₂, BaSO₄, clay, such as kaolin, styrene-acrylic copolymer, Mg—Al-silicate, and the like. These pigments can be used individually or in mixtures.

The major part of the pigment particles are preferably smaller than 2 μm, preferably smaller than 1 μm, and the pigment particles have a narrow size distribution (e.g. up to 70 wt. % or more of the particles having an average particle diameter that is between 0.35 and 1 μm). Suitable pigments that meet the requirement of the above-mentioned small particle size distribution are e.g. those commercially available from Imerys Minerals Ltd. under the trade names Supraflex™ 80 and Alphatex™. Preferably the pigment layer comprises calcium carbonate.

Application of this pigmented coating may be done in various stages of the manufacturing process and is preferably done at ambient temperatures viz. between 20 and 60° C.

In one embodiment, the pigmented coating is applied during the speed sizing process, by incorporating pigment in the speed sizing mixture.

In another embodiment the pigmented coating is applied on a web without speed sizing by conventional methods such as a size-, film-press, speedsizer, air knife coater, bill-blade coater and the like.

In another embodiment a pigmented coating layer can be applied by the methods described above on a base material provided with a pigmented speed sizing. In this case more thick pigmented coatings can be applied.

After the application of the pigmented coating the paper can be dried. By coating the paper surface with a pigmented speed-sizing coating and/or a pigmented surface coating, the surface roughness is significantly reduced. The result is, that the development of crater defects during extrusion coating is significantly reduced. Pigment coating is most effective for low-quality papers.

Depending on the required quality, the pigmented base paper may be calendered. The calendering in combination with the outer pigmented surface coating results in a substantially reduced average surface roughness, R_{A}, which is determined at the top side of the surface of the pigment coated base paper and is preferably 1.0 μm or less. The surface roughness R_{A}, is measured according to DIN 4776; software package version 1.62 with the following settings: (1) Point density 500 P/mm (2) Area 5.6×4.0 mm² (3) Cut-off wavelength 0.80 mm (4) Speed 0.5 mm/sec., using a UBM equipment. When the average surface roughness exceeds the value of about 1.0 μm, crater defects can easily develop during the extrusion coating.

Preferably the paper coating, paper structure and the optional calendering treatment are such that the paper surface has an average surface roughness R_{A} of 0.8 μm or less, as it has been found that the amount of crater defects is reduced with decrease of average surface roughness. Also good behaviour with respect to gloss and to the development of pits or crater defects during extrusion coating is obtained with surface roughness values around R_{A} of 0.5 μm.

Good quality paper, having already the required surface roughness value after pigment coating, need not to be calendered; paper not having the required roughness value, usually prepared from lesser quality material, will be subsequently calendered.

Another aspect of the calendering treatment is the effect thereof on the paper thickness and accordingly on the stiffness. It is preferred to have a coated base paper with a total weight of at least 150 g/m² preferably between 150 and 210 g/m², in combination with a thickness of at least 145 μm, preferably between 150 and 180 μm. In these ranges an optimal combination of the various properties is obtained. The paper weight limitations described above are valid for a photo grade quality paper. The present invention is not limited to these paper weights as the same improvements of the present invention can also be achieved using base paper with a weight as low as 80 g/m². The paper weight is defined herein as the weight of the base paper and any surface coating that may be present, however excluding the polymer resin and additional coatings like photographic emulsions.

The base sheet provided with the outer pigmented speed sizing and/or surface pigment coating is further extrusion coated with a polymer resin filled with metal oxide. When a pigment coated base paper, having an average surface roughness of 1.0 μm or less, is used, it is possible to laminate the paper using very high (co-)extrusion speeds, without running into problems with crater defects on the surface of the paper. Keeping the said speeds at lower levels provides the possibility to reduce the amount of polymer resin, without having the crater defect problems. The extrusion coating is performed by (co-)extrusion using thin layer(s) of polymer, which can be applied at high speed. The resin at the front side of the photographic support may have a mono- or a multi-layer structure. The multi-layer structure can be obtained with stepwise extrusion of mono-layers or, preferably, in a co-extrusion coating system.

The pigment coated surface of the base sheet is subjected to an activating treatment prior to (co-)extrusion coating with at least one polymer layer. An activating treatment can be a corona discharge treatment and/or a flame treatment and/or a plasma treatment and/or a NIR (near infra-red) treatment.

The corona discharge treatment is known to those skilled in the art and can be carried out as described in, for example, U.S. Pat. No. 3,411,908. Examples of appropriate corona discharge treatments are further described in GB-A-0 971 058, GB-A-1 005 631, GB-A-1 060 526, GB-A-1 019 664, GB-A-1 043 703, GB-A-1 134 211, GB-A-1 136 902, GB-A-0 870 224, GB-A-0 771 234, GB-A-0 715 914, U.S. Pat. No. 0,989,377, U.S. Pat. No. 3,253,922, U.S. Pat. No. 3,549,406, U.S. Pat. No. 3,520,242, U.S. Pat. No. 3,076,720, et cetera.

The corona discharge treatment is preferably applied with a load of at least 15 Watt/(min-m²), more preferably at least 20 Watt/(min-m²) and most preferably with a load of at least 40 Watt/(min-m²). Preferably the load is less than about 120 Watt/(min-m²). At loads between 40 and 120 Watt/(min-m²) the adhesion improvement effect levels off and reaches a saturation level. The load at which saturation occurs varies with the web speed. Higher speeds generally require higher loads.

If necessary, the surface of the base sheet not comprising a pigment coating is also subjected to an activation treatment before the melt-extrusion process. The treatment may comprise a corona treatment and/or a flame treatment and/or ozone treatment and/or plasma treatment and/or NIR treatment. An activation treatment can also be applied to the front and/or back surface after (co-)extrusion coating of the pigment coated base.

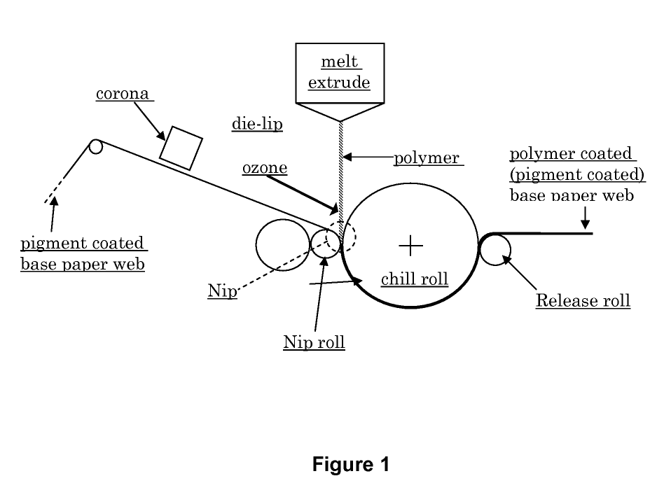

In FIG. 1 an example of an extrusion-coating line is schematically shown, wherein a polymer is coated by melt-extrusion on a pigment coated base paper, in accordance with the present invention. Referring to FIG. 1, the pigment coated base-paper is fed, via a number of rollers, past a corona treatment, via the nip-roll to the nip-zone. The polymer is molten and extruded through the die-lip with a polymer melt temperature of about 230° C. to about 340° C. Preferably the polymer melt has a temperature of about 280° C. to about 330° C. and even more preferably between about 300° C. and 325° C. The die lip is operated at a temperature of between 290 and 370° C., preferably between 310 to 360° C. The die lip temperature of about 325 to 350° C. is preferred as this will give an improved adhesion. Too low die lip temperatures viz. below 300° C. gives a too cold polymer melt resulting in an increased number of pit-defects. Too high die lip temperatures cause line defects in the polymer melt.

The polymer melt and the pigment coated base paper come together in the nip. The melt gap, which is the distance between the extruder die lip and the nip, where the polymer melt is added, can be varied.

In accordance with the invention, an oxidizing gas is applied to the melt before the polymer melt contacts the pigment coated base paper, that is, in the nip-area at or just before the nip. The oxidizing gas is preferably selected from the group comprising oxygen, nitrogen dioxide and ozone. The amount of oxidising gas necessary to achieve an improvement in adhesion is at least 2.0 mg/m² and more preferably higher than 3.5 mg/m² and very good adhesion is achieved using 5 mg/m² for web speeds of 300 m/min or higher. When applying higher amounts of ozone than 10 mg/m² no additional improvement is observed; a saturation level is reached. The polymer melt, now laminated onto the pigment coated base paper, is then cooled on the chill-roll and is released from the chill-roll at the release-roll, from where it is transported further.

At low web speeds of 280 m/min or less, the polymer melt adheres sufficiently to the pigment coated paper base. When increasing the web speed to more than 300 m/min, this adhesion becomes progressively worse. Conventional methods to improve adhesion like increasing the polymer melt temperature or increasing the melt gap result in a minor improvement, but are insufficient for melt extrusion with web speeds of over 300 m/min.

We found, against expectation, that adhesion improves significantly when an oxidising gas such as ozone is applied.

It is to be noted that the present figure shows lamination on only one side of the pigmented paper base. In case lamination on both sides has to be provided, the partly laminated paper base can be laminated on the other side in a comparable co-extrusion line. It is also possible to include a second extruder.

As polymer resin used in the co-extrusion process, polyester and homopolymers of alpha-olefins such as polyethylene, polypropylene and the like, copolymers of two or more olefins such as ethylene-propylene copolymer, ethylene butylene copolymer, ethylene octene copolymer and mixtures thereof can be applied. Particularly preferred polyolefins are high density polyethylene, low density polyethylene and mixtures thereof. In case the resin layer is of the multi-layer type, resins in each layer may differ from each other in chemical structure or in physical properties such as melt indexes.

The polymer resin layer will generally contain additives such as white pigment e.g. metal oxides such as titanium dioxide and zinc oxide and inorganic fillers such as calcium carbonate, dyes, coloured pigments, adhesion promoters, optical brighteners, antioxidant and the like. The polymer resin layer on the side on which an additional coating is applied as for example a photographic emulsion will preferably contain a white pigment and a coloured pigment or dyes.

The photographic printing paper is obtained by applying a photographic emulsion layer or layers on the polymer resin coated paper. The application of the photographic emulsion can be done in any way and is well-known to the skilled person.

Ink jet printing paper is obtained by applying an ink receiving layer or layers on the polymer resin coated paper as is well known to the skilled person. In addition to photographic or inkjet paper the method of this invention is also suitable for use in the manufacturing of other recording materials and for use in the preparation of base materials in other applications such as packaging materials

The invention is now further elucidated on the basis of the following examples.

### EXAMPLES

In the examples the following method was used for determining adhesion: Zwick 1425 tensile tester, sample width 15 mm, peeling angle 180°, clamp distance 2.3 cm, peeling speed 50 mm/min.

For evaluating the adhesion strength the following symbols are used:

| Symbol | Adhesion force in Newton (N) |
|---|---|
| ◯ | Excellent adhesion; peeling test results in tearing fibers |
| | off the paper base |
| Δ/◯ | Good adhesion; polymer layer releases at force of higher |
| | than 2.0 |
| Δ | Acceptable adhesion; polymer layer releases at force |
| | between 1.5 and 2.0 |
| X | Inferior adhesion; polymer layer releases at force between |
| | 0.5 and 1.5 |
| XX | Unacceptable adhesion; polymer layer releases at force less |
| | than 0.5 |

A high quality base paper, prepared using a starch based internal sizing agent which contains optical brightener, was used. The internal sized base paper is pre-calendered such that the bulk density and therefore in particular the surface density is increased. The surface is smoothened in order to close the pores at the surface preventing that the sizing solution will penetrate too deeply inside the paper bulk. Then, this was treated with a thermally modified non-ionic starch as speed sizing material. The starch was dispersed in an 1.8% (w/v) aqueous NaCl solution and heated at 120° C. for two hours under vigorous stirring. The viscosity (Brookfield at 100 rpm) of the speed-sizing solution ranges between 150-480 mPa.s. To the speed sizing solution a pigment (precipitated calcium carbonate, CaCO₃, Faxe™ C—R60) is added in an amount of 3 g/m², obtaining a base paper coated with a pigment layer. After speed sizing using the pigmented mixture and drying, the sample was finish-calendered until a bulk density ranging between 0.95-1.00 g/cm³. The surface roughness was 0.6 μm.

The thus obtained pigment coated paper was extrusion coated at the pigment coated side with an LDPE monolayer of 29 g/m² with varying line speed, melt gap and temperatures as illustrated in Examples 1 and 2. The pigment coated base is subjected to a corona treatment of 40 to 50 Watt/(min·m²) before it is extrusion coated with a nip roll pressure of between 400 and 800 N/cm² at a glossy cooling roll. The LDPE contains colouring agents, titanium dioxide and brightening agents.

As a reference a base paper was prepared as above, without the addition of the pigment during speed-sizing.

According to the invention, ozone was applied at the polymer melt, prior to extrusion coating.

### Example 1

Extrusion coating of a pigment coated and a non pigment coated base was carried out as described above. The effect of varying melt gap is shown in Table 1.

TABLE 1

| Condition | | | Adhesion | | | |
|---|---|---|---|---|---|---|
| Web speed | Melt gap | Ozone | non pigment | pigment | | |
| (m/min) | (mm) | (mg/m2) | coated base | coated base | example | |
| 400 | 205 | 0 | ◯ | Δ | 1.1 | ref. |
| | | 5.8 | ◯ | ◯ | 1.2 | inv. |
| | | 8.3 | ◯ | ◯ | 1.3 | inv. |
| | 250 | 0 | ◯ | Δ/◯ | 1.4 | ref. |
| | | 5.8 | ◯ | ◯ | 1.5 | inv. |
| | | 8.3 | ◯ | ◯ | 1.6 | inv. |
| 500 | 205 | 0 | ◯ | X | 1.7 | ref. |
| | | 4.7 | ◯ | Δ/◯ | 1.8 | inv. |
| | | 6.7 | ◯ | ◯ | 1.9 | inv. |
| | 250 | 0 | ◯ | Δ | 1.10 | ref. |
| | | 4.7 | ◯ | Δ/◯ | 1.11 | inv. |
| | | 6.7 | ◯ | ◯ | 1.12 | inv. |
| 600 | 205 | 0 | ◯ | XX | 1.13 | ref. |
| | | 3.9 | ◯ | Δ/◯ | 1.14 | inv. |
| | | 5.6 | ◯ | ◯ | 1.15 | inv. |
| | 250 | 0 | ◯ | X | 1.16 | ref. |
| | | 3.9 | ◯ | Δ/◯ | 1.17 | inv. |
| | | 5.6 | ◯ | ◯ | 1.18 | inv. |

In all examples the amount of pits after extrusion coating on the non pigment coated samples was significantly worse than for the pigment coated samples.

Furthermore the example shows that conventional paper base lacking a pigment coating can be extrusion coated with high production speeds without the application of ozone. In case of a pigment coated paper adhesion gets progressively worse with increased production speed. Examples 1.1; 1.4; 1.7; 1.10; 1.13; and 1.16 show that increasing the melt gap gives some improvement at lower speeds. Further increase of the gap is technically not feasible. To obtain an acceptable result at the preferred, smaller melt gap, application of ozone is shown to be necessary. Further it is visible that at least 3.9 mg/M² ozone amount is needed for getting a good adhesion property at high web speeds and more preferably higher than 5 mg/m² to obtain excellent adhesion property for the inventive examples.

### Example 2

Extrusion coating of a pigment coated and a non pigment coated base was carried out as described above. The effect of varying die-lip temperature is shown in Table 2.

TABLE 2

| Condition | | | Adhesion | | | |
|---|---|---|---|---|---|---|
| Web speed | die-lip | Ozone | non pigment | pigment | | |
| (m/min) | temp. (° C.) | (mg/m2) | coated base | coated base | example | |
| 325 | 325 | 0 | ◯ | Δ | 2.1 | ref. |
| | | 7.2 | ◯ | ◯ | 2.2 | inv. |
| | | 10.3 | ◯ | ◯ | 2.3 | inv. |
| | 345 | 0 | ◯ | Δ/◯ | 2.4 | ref. |
| | | 7.2 | ◯ | ◯ | 2.5 | inv. |
| | | 10.3 | ◯ | ◯ | 2.6 | inv. |
| 420 | 325 | 0 | ◯ | X | 2.7 | ref. |
| | | 5.5 | ◯ | Δ/◯ | 2.8 | inv. |
| | | 7.9 | ◯ | ◯ | 2.9 | inv. |
| | 345 | 0 | ◯ | Δ | 2.10 | ref. |
| | | 5.5 | ◯ | Δ/◯ | 2.11 | inv. |
| | | 7.9 | ◯ | ◯ | 2.12 | inv. |
| 500 | 325 | 0 | ◯ | XX | 2.13 | ref. |
| | | 4.7 | ◯ | Δ/◯ | 2.14 | inv. |
| | | 6.7 | ◯ | ◯ | 2.15 | inv. |
| | 345 | 0 | ◯ | X | 2.16 | ref. |
| | | 4.7 | ◯ | Δ/◯ | 2.17 | inv. |
| | | 6.7 | ◯ | ◯ | 2.18 | inv. |

In all examples the amount of pits after extrusion coating on the non pigment coated samples was significantly worse than for the pigment coated samples.

Furthermore the example shows that conventional paper base lacking a pigment coating can be extrusion coated with high production speeds without the application of ozone even at decreased die-lip temperatures. In case of a pigment coated paper adhesion gets progressively worse with increased production speed, especially at a lower die-lip temperature as illustrated by example 2.1; 2.4; 2.7; 2.10; 2.13 and 2.16.

A higher die-lip temperature is not preferred because of the occurrence of line-defects that accompany such a temperature increase. To obtain an acceptable result at the preferred, lower die-lip temperature application of ozone is shown to be necessary. Furthermore it is visible that at least 4.7 mg/m² ozone amount is needed to obtain good adhesion property at high web speeds.

### Example 3

### Activating Treatment

Extrusion coating of a pigment coated base was carried out as described above with a melt-gap of 205 mm and a die-lip temperature of 325° C. The corona output prior to extrusion coating of the pigment coated base paper was varied. Extrusion coating was done at a web speed of 500 m/min. Ozone was applied in an amount of 6.7 mg/m². As a reference, no ozone was applied.

Adhesion

| Corona output | Inventive; ozone | Reference; no |
|---|---|---|
| (Watt/(min · m2)) | applied | ozone applied |
| 0 | X | XX |
| 20 | Δ/◯ | XX |
| 40 | ◯ | X |
| 120 | ◯ | X |

The example shows that an activation treatment is necessary for extrusion coating a pigment coated base paper, even when applying ozone. Activation reaches ‘saturation’ at a certain corona output after which further increase of the output gives little or no further improvement. In the current example ‘saturation’ is reached at about 40 Watt/(min·m²), but this may vary with different types of pigment coated base papers. Similar results were obtained when applying a plasma treatment instead of a corona treatment. A skilled person will optimise the output of the activation treatment depending on the pigment coated base paper type.

1. A method for manufacturing a paper support comprising:
providing a support having a top side and a back side, at least said topside being provided with a pigmented coating;
applying an activating treatment to a pigment coated surface of said support;
providing a polymer melt;
contacting said polymer melt with an oxidising gas; and
laminating said pigment coated surface of said support with at least one layer of said polymer melt by contacting said support with the side of said melt that has been contacted with said oxidising gas.

2. A method according to claim 1 in which the oxidising gas is ozone.

3. A method according to claim 1 in which the oxidising gas is applied in an amount of at least 2.0 mg/m2 of said support.

4. A method according to claim 1 in which the oxidising gas is applied in an amount of at least 3.5 mg/m2 of said support.

5. A method according to claim 1 wherein the activating treatment is a corona treatment, a plasma treatment, a flame treatment, or NIR treatment.

6. A method according to claim 1 wherein the activating treatment is a corona treatment of at least 20 Watt/(min·m2).

7. A method according to claim 1 wherein the activating treatment is a corona treatment of at least 40 Watt/(min·m2).

8. A method according to claim 1 wherein at least one of said polymer layers comprises pigments including metal oxides, titanium dioxide and zinc oxide, and inorganic fillers including calcium carbonate.

9. A method according to claim 1 wherein the pigmented coating comprises clay or other pigment.

10. A method according to claim 1 wherein said polymer layer comprises a polymer selected from the group consisting of polyolefins and polyesters.

11. A method according to claim 1 wherein said polymer layer is extruded at a die-lip temperature of between 290° C. and 370° C.

12. A method according to claim 1 wherein said polymer layer is extruded at a die-lip temperature of between 310° C. and 360° C.

13. A method according to claim 1 wherein said polymer layer is extruded at a die-lip temperature of between 325° C. and 350° C.

14. Paper support having a topside and a backside, at least said topside being provided with a pigmented coating based on clay or other pigment, which support is provided with at least one pigmented polymer resin layer, wherein an activating treatment has been applied to said pigmented coating and said resin layer has been exposed to an oxidizing gas prior to lamination on said activated pigmented coating.
